(19) United States
(12) Patent Application Publication
(10) Pub. No.: US 2018/0117710 A1
(43) Pub. Date: May 3, 2018

(54) LASER SYSTEM AND LASER FLARE MACHINING METHOD

(71) Applicant: INDUSTRIAL TECHNOLOGY RESEARCH INSTITUTE, Hsinchu (TW)

(72) Inventors: Shih-Ting LIN, Tainan City (TW); Ying-Tso LIN, Hualien City (TW); Hong-Xi TSAU, Tainan City (TW)

(73) Assignee: INDUSTRIAL TECHNOLOGY RESEARCH INSTITUTE, Hsinchu (TW)

(21) Appl. No.: 15/388,445

(22) Filed: Dec. 22, 2016

(30) Foreign Application Priority Data
Nov. 2, 2016 (TW) 105135593

(51) Int. Cl. B23K 26/067; B23K 26/06

(52) U.S. Cl. CPC B23K 26/0676; B23K 2203/05; B23K 26/0648

(57) ABSTRACT

Disclosed is a laser system and a laser flare machining method. The laser system includes a laser light source, a splitter element, and a scanning lens assembly. The laser light source projects a first light beam. The splitter element is furnished on a first path along which the first light beam travels, and splits the first light beam into a second light beam traveling along a second path and a third light beam traveling along a third path. The scanning lens assembly is furnished on the second path and the third path, and focus the second light beam and the third light beam at a machining position to process a work piece.

### CROSS-REFERENCE TO RELATED APPLICATIONS

This non-provisional application claims priority under 35 U.S.C. § 119(a) on Patent Application No(s). 105135593 filed in Taiwan, R.O.C. on Nov. 2, 2016, the entire contents of which are hereby incorporated by reference.

### TECHNICAL FIELD

The disclosure relates to a laser system and a laser flare machining method.

### BACKGROUND

Application fields of laser nowadays can be classified into lighting type, detection type, material heat treatment type and material ablation type. The lighting type application field includes laser lighting shows, laser pointers and so on. Detection type application field includes barcode scanners, optical disc players, fiber-optic communication, laser spectroscopy, laser ranging, laser radars, laser indicators, laser scanning, fingerprint identification and so on. Material heat treatment or welding type application field includes bloodless surgery, laser printers, laser annealing, welding, and so on. Material ablation type application field includes cutting, perforating, laser eye treatment, laser marking, laser engraving, and so on.

Modern laser engraving technologies are usually to perform material heat treatment or material ablation onto the surface of an object. A mark formed on such an object subjected to the laser engraving process has advantages in terms of counterfeiting difficulty, definition, persistence, abrasion resistance and so on. These conventional laser engraving technologies in the art include forming a pattern on the surface of an object by machining the surface of the object, and such a surface pattern has a texture different from that of the object, but substantially has the same color as the object. These conventional laser engraving technologies in the art also include forming a single-color pattern on the surface of an object by laser-machining the surface of the object, and the pure color of such a pattern is different from the original color of the object; and however, forming a pattern having a pure color on the surface of an object cannot satisfy various requirements of modern people.

### SUMMARY

According to one or more embodiments, the disclosure provides a laser system including a laser light source, a splitter element and a scanning lens assembly. The laser light source projects a first light beam. The splitter element is furnished on a first path, along which the first light beam travels, and splits the first light beam into a second light beam traveling along a second path and a third light beam traveling along a third path. The scanning lens assembly is furnished on the second path and the third path and focuses the second light beam and the third light beam at a machining position to process a work piece.

According to one or more embodiments, the disclosure provides a laser flare machining method includes the following steps: projecting a first light beam along a first path from a laser light source; by a splitter element, splitting the first light beam into a second light beam traveling along a second path and a third light beam traveling along a third path; and focusing the second light beam and the third light beam at a machining position to process a work piece by a scanning lens assembly.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic structure diagram of a laser system 1 according to an embodiment of the disclosure;

FIG. 2 is a schematic diagram of the enlargement of the surface of a 304 stainless steel work piece subjected to a laser flare machining method by the laser system;

FIG. 3 is a schematic diagram of the enlargement of the surface of a 430 stainless steel work piece subjected to a laser flare machining method by the laser system;

FIG. 4 is a schematic structure diagram of a laser system according to another embodiment of the disclosure;

FIG. 5 is a spectrum that a X-ray photoelectron spectroscopy test is performed on the work piece; and

FIG. 6 is a spectrum that the laser flare machining method is performed on the work piece by the laser system.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The sizes, proportional relation and angles of members shown in the respective drawings are occasionally exaggerated for clarifying the illustration, but are not used to limit the disclosure. They can be modified without departing from the gist of the disclosure.

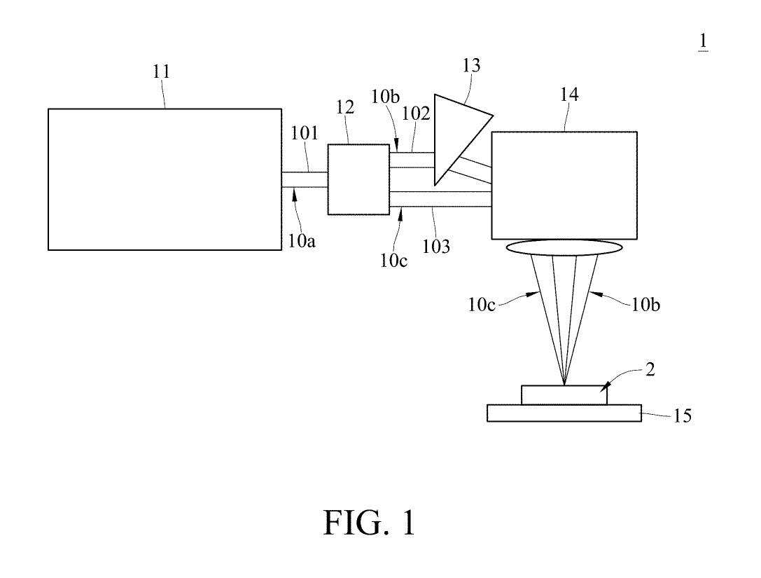

Please refer to FIG. 1 that illustrates the structure of a laser system 1 according to an embodiment of the disclosure. In this embodiment, the laser system 1 includes a laser light source 11, a splitter element 12, an angle adjusting member 13, a scanning lens assembly 14, and a work platform 15.

The laser light source 11 emits a first light beam 10a. In the spectrum, the peak wavelength of the first light beam 10a falls in a range of 1059 nm˜1075 nm. The full width at half maximum (FWHM) value of the first light beam 10a falls in a range of 2 nm˜6 nm. A FWHM value is the difference in wavelength between the two extreme wavelengths corresponding to a half of a peak value of an intensity peak in a spectrum. The power value of the laser light source 11 ranges 25 W˜50 W. The pulse repetition rate of the laser light source 11 ranges 10 KHz˜500 KHz.

The splitter element 12 is furnished on a first path 101 of the first light beam 10a. The splitter element 12 splits the first light beam 10a into a second light beam 10b traveling along a second path 102 and a third light beam 10c traveling along a third path 103. The distance between the second path 102 and the third path 103 ranges 0.5 mm˜3 mm. When the distance between the second path 102 and the third path 103 is smaller than 0.5 mm, light splitting may not be recognized. When the distance between the second path 102 and the third path 103 is larger than 3 mm, a scanning lens assembly 14 described later may difficultly make the second light beam 10b and the third light beam 10c converge.

The angle adjusting member 13 is disposed to the splitter element 12 and is located on the second path 102. The angle adjusting member 13 slightly adjusts the traveling direction of the second light beam 10b. Moreover, if the angle between the path of the second light beam 10b and the path of the third light beam 10c matches the requirement of the scanning lens assembly 14, the angle adjusting member 13 can be omitted.

The scanning lens assembly 14 is furnished on the second path 102 and the third path 103. The angle adjusting member 13 is located between the splitter element 12 and the scanning lens assembly 14. The scanning lens assembly 14 focuses the second light beam 10b and the third light beam 10c on at least a machining position to process a work piece 2. At the machining position, the center of the second light beam 10b and the center of the third light beam 10c have a distance of lass than 10 mm therebetween. The focal length of the scanning lens assembly 14 ranges 250 mm˜300 mm. The scanning lens assembly 14 is fixed focal length type or variable focal length type. If the scanning lens assembly 14 is variable focal length type, the focal length of the scanning lens assembly 14 can be adjusted in a range of 250 mm˜300 mm. The scanning lens assembly 14 is fixed machining position type or variable machining position type.

The work platform 15 bears the work piece 2. The work platform 15 is immovable type or movable type. If the scanning lens assembly 14 is fixed machining position type, the work platform 15 belonging to the movable type can be chosen, so as to move the work piece 2 to the machining position. If the scanning lens assembly 14 is variable machining position type, the work platform 15 belonging to the immovable type or the movable type can be chosen.

By the laser system 1, a laser flare machining method is performed and includes the following steps.

The work piece 2 is furnished on the work platform 15, and the position of the work piece 2 is also adjusted.

The laser light source 11 is programmed to project the first light beam 10a along the first path 101. In the spectrum, the peak wavelength of the first light beam 10a ranges 1059 nm˜1075 nm, the FWHM value of the first light beam 10a ranges 2 nm˜6 nm, the power value of the laser light source 11 ranges 25 W˜50 W, and the pulse repetition rate of the laser light source 11 ranges 10 KHz˜500 KHz.

The splitter element 12 is programmed to split the first light beam 10a into the second light beam 10b traveling along the second path 102 and the third light beam 10c traveling along the third path 103. The distance between the second path 102 and the third path 103 ranges 0.5 mm˜3 mm.

The angle adjusting member 13 is programmed to adjust the traveling direction of the second light beam 10b.

The scanning lens assembly 14 is programmed to focus the second light beam 10b and the third light beam 10c at a machining position on the work piece 2, in order to process the work piece 2 at the machining position. At the machining position, the center of the second light beam 10b and the center of the third light beam 10c have a distance of less than 10 mm therebetween. The focal length of the scanning lens assembly 14 ranges 250 mm˜300 mm.

After the work piece 2 at the machining position is processed, the scanning lens assembly 14 or the work platform 15 is programmed to adjust the position on the work piece 2, on which the second light beam 10b and the third light beam 10c converge, so that the second light beam 10b and the third light beam 10c overlap on the position to machine the work piece 2.

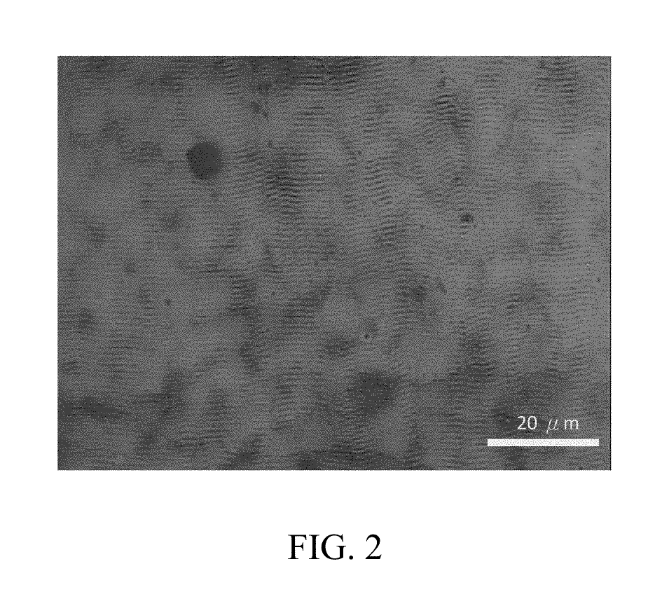

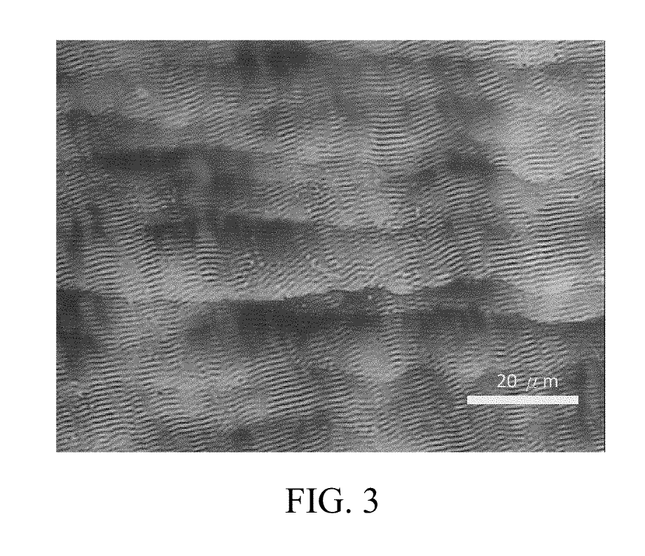

Please refer to FIG. 2 and FIG. 3. FIG. 2 is a schematic diagram of the enlargement of the surface of a 304 stainless steel work piece subjected to a laser flare machining method by the laser system, and FIG. 3 is a schematic diagram of the enlargement of the surface of a 430 stainless steel work piece subjected to a laser flare machining method by the laser system. In view of FIG. 2 and FIG. 3, the surface of the work piece forms a nano-scale corrugated structure after subjected to the laser flare machining method by the laser system 1, and the basic color of the work piece is changed to a color different from the original color of stainless steel. Variations in the basic color of a work piece may be caused by a chemical change, such as oxidization, in a laser heating process. Moreover, after visible light shines on the work piece that has been subjected to the laser flare machining method by the laser system 1, because a nano-scale structure may cause interference in the reflection of the visible light and light in a different wavelength has a different expression, the entire reflected light may have a different light distribution from a different angle. Therefore, a viewer can see various colors when seeing the machined work piece at different angles of viewing.

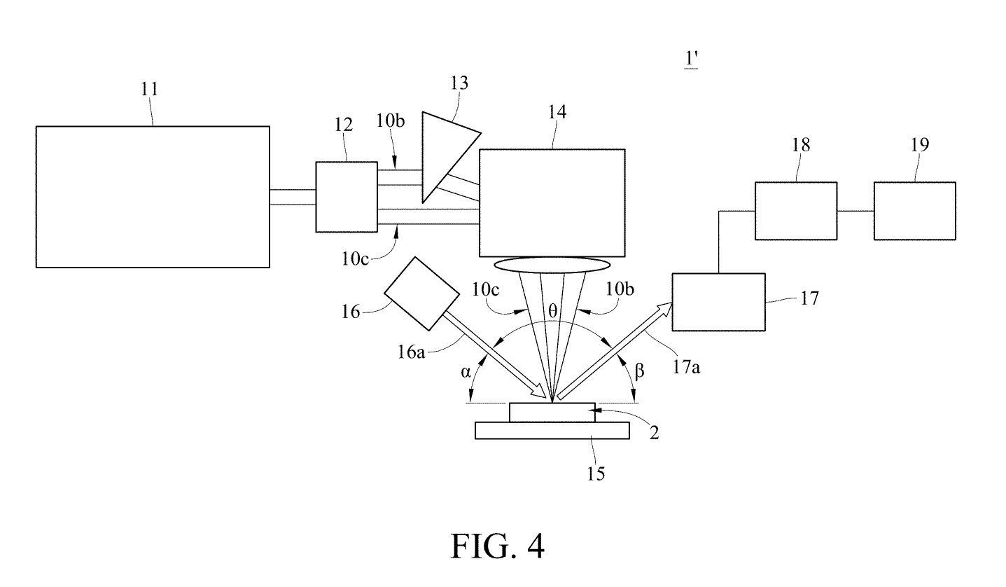

Please refer to FIG. 4. FIG. 4 is a schematic structure diagram of a laser system 1′ according to another embodiment of the disclosure. The laser system 1′ in this embodiment is similar to the laser system 1 in FIG. 1, and thus the description of the same components is omitted hereafter. As compared to the laser system 1 in FIG. 1, the laser system 1′ further includes a detecting light source 16, a sensor 17, a processing unit 18, and a storage unit 19.

The detecting light source 16 can be movably disposed to the work platform 15. The detecting light source 16 projects at least one detecting light beam along an emitting direction 16a onto the work piece 2 bore by the work platform 15. In an example, such a detecting light beam is visible light, and its wavelength range is 400 nm˜750 nm. In another example, the detecting light beam is mixed light of light of a number of colors or is white light, monochromatic light. The emitting direction 16a has an angle α with the surface of the work piece 2.

The sensor 17 is movably disposed to the work platform 15. In an example, the sensor 17 is a spectrum sensor or spectrometer. The sensor 17 receives light traveling along a detecting direction 17a from the work piece 2, to obtain light data corresponding to the work piece 2. The detecting direction 17a has an angle β with the surface of the work piece 2. The angle α and the angle β are the same or different from each other according to practical requirements. The emitting direction 16a has an angle θ with the detecting direction 17a. The angle θ exemplarily ranges 30˜100 degrees.

The processing unit 18 is connected to the sensor 17. The storage unit 19 is connected to the processing unit 18, and the storage unit 19 is connected to the sensor 17 through the processing unit 18. The processing unit 18 stores the light data obtained by the sensor 17 into the storage unit 19. Moreover, the storage unit 19 can also store a number of references corresponding to work pieces 2 that are formed of different materials, are detected via different detecting light sources, or are processed by different machining conditions. The processing unit 18 compares the light data obtained by the sensor 17 with a reference stored in the storage unit 19, to determine the material of the work piece 2.

By the laser system 1′, another laser flare machining method can be carried out. The laser flare machining method carried out on the laser system 1′ is similar to the laser flare machining method carried out on the laser system 1, and thus, the description of the same steps is omitted hereafter. As compared to the laser flare machining method carried out on the laser system 1 in FIG. 1, the laser flare machining method carried out on the laser system 1′ further includes the following steps.

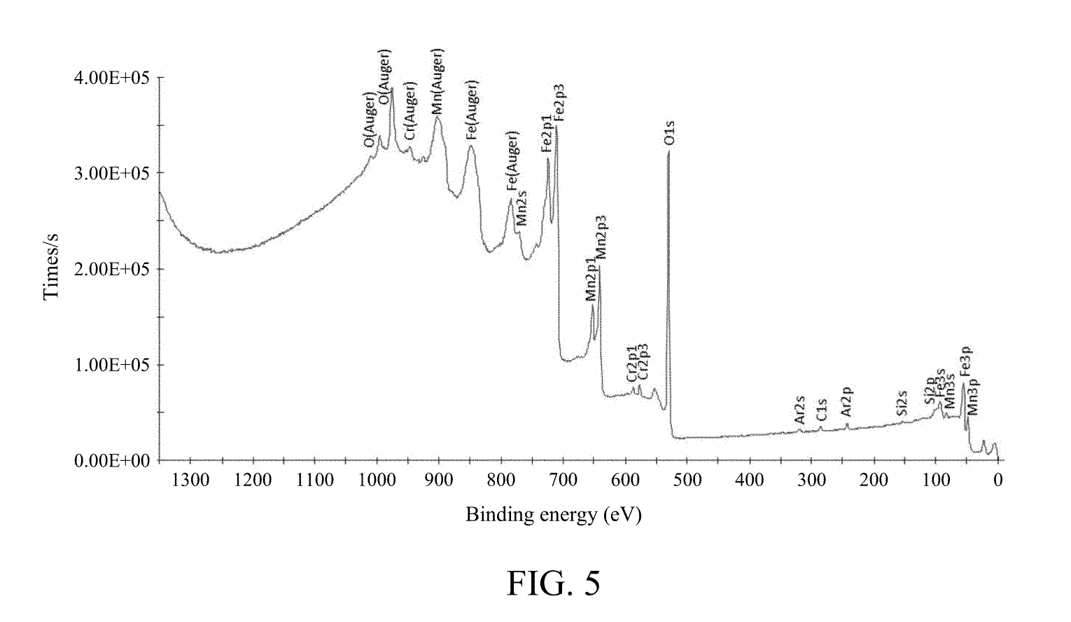

Please refer to FIG. 5. FIG. 5 is a spectrum that an X-ray photoelectron spectroscopy (XPS) test is performed on the work piece 2. Through the spectrum, as shown in FIG. 5, obtained by performing the XPS test onto the work piece 2, the constituents and their proportion of the material of the work piece 2 may be learned. In another embodiment, the XPS test is replaced by an electron phenomenological spectroscopy (EPS) test. In another embodiment, if the material of the work piece 2 has been known, the XPS test or the EPS test can be omitted.

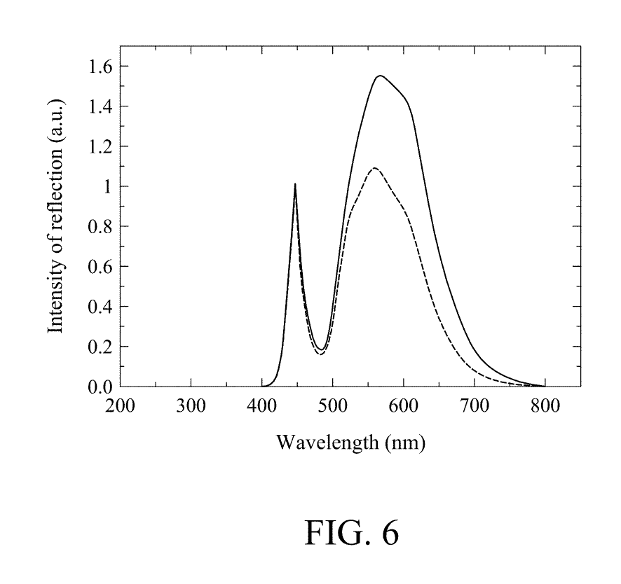

Please refer to FIG. 6 that exemplarily illustrates the spectrum obtained by performing the laser flare machining method onto the work piece 2 by the laser system 1′ as the material of the work piece 2 has been known. Under the premise that the material of the work piece 2 has been known in advance, after the scanning lens assembly 14 focuses the second light beam 10b and the third light beam 10c on the machining position on the work piece 2 to process the work piece 2 at the machining position, the detecting light source 16 is programmed to project a detecting light beam along the emitting direction 16a onto the work piece 2 and the sensor 17 is also programmed to receive light traveling along the detecting direction 17a from the work piece 2, to obtain the light data corresponding to the work piece 2, such as a solid line spectrum in FIG. 6. The processing unit 18 further stores the light data, obtained by the sensor 17, into the storage unit 19, and such light data can be used in the feature as a reference to analyze the material of the work piece 2 that has not known yet.

Furthermore, under the premise that the material of the work piece 2 has been known in advance, it can optionally be done to change the angle α between the emitting direction 16a and the work piece 2, the angle β between the detecting direction 17a and the work piece 2, or the angle θ between the emitting direction 16a and the detecting direction 17a, control the detecting light source 16 to project a detecting light beam along the emitting direction 16a onto the work piece 2, and control the sensor 17 to receive light, which travels along the detecting direction 17a from the work piece 2, to obtain another light data corresponding to the work piece 2 in another situation. For example, such another light data is a dotted line spectrum in FIG. 6. The processing unit 18 stores such another light data into the storage unit 19, and such another light data can also serve as another reference in the feature to analyze the material of the work piece 2 that has not been known yet.

By repeating the above steps onto a number of work pieces 2 formed of different known materials, a number of references for these work pieces 2 can be obtained to establish a database in the storage unit 19.

In addition, for the work piece 2 whose material has not been known yet, the scanning lens assembly 14 is programmed to focus the second light beam 10b and the third light beam 10c on the machining position on the work piece 2 to process the work piece 2. Moreover, the detecting light source 16 is programmed to project a detecting light beam along the emitting direction 16a onto the work piece 2, and the sensor 17 is also programmed to receive light traveling along the detecting direction 17a from the work piece 2, to obtain the light data corresponding to the work piece 2 in this situation.

The processing unit 18 compares the light data with a reference. If the comparison result is that they match each other, it denotes that the material of the work piece 2 that has not known yet is the same as the material of the work piece 2 that has been known in advance. Therefore, the laser system 1′ can detect the material of the work piece 2 that is unknown after processing the work piece 2 at the machining position. Next, the user can also use the spectrum of the XPS test, as shown in FIG. 5, to do other task or research.

Generally, the time for the sensor 17 to receive light and for the processing unit 18 to perform comparison and determination to the light data is much shorter than the time to do the XPS test. Therefore, under the premise that a database has been established, the laser system 1′ and the laser flare machining method thereof can immediately, fast detect the material of a great deal of work pieces 2 that is unknown.

To sum up, the laser system and the laser flare machining method in an embodiment of the disclosure split a first light beam, outputted by a laser light source, into branches and then make these branches converge at a machining position in order to process a work piece so that this work piece forms a pattern having a flaring effect. Flaring effect means that the color of the pattern varies at different angles. Therefore, a pattern on a work piece can have various expressions, and the difficulty in counterfeiting a pattern increases, resulting in the enhancement of anti-counterfeiting effect.

Moreover, the laser system and the laser flare machining method in another embodiment of the disclosure further make a second light beam and a third light beam converge to process the work piece, and meanwhile, immediately, fast detect the material of the work piece via a detecting light source and a sensor.

What is claimed is:

1. A laser system, comprising:
a laser light source for emitting a first light beam;
a splitter element furnished on a first path of the first light beam and configured to split the first light beam into a second light beam traveling along a second path and a third light beam traveling along a third path; and
a scanning lens assembly furnished on the second path and the third path and for focusing the second light beam and the third light beam at a machining position to process a work piece.

2. The laser system according to claim 1, wherein a peak wavelength of the first light beam ranges 1059 nm˜1075 nm, a full width at half maximum (FWHM) value of the first light beam ranges 2˜6 nm, a power value of the laser light source ranges 25 W˜50 W, and a pulse repetition rate of the laser light source ranges 10 KHz˜500 KHz.

3. The laser system according to claim 1, wherein a distance between the second path and the third path is 0.5 mm˜3 mm.

4. The laser system according to claim 1, wherein a focal length of the scanning lens assembly ranges 250 mm˜300 mm.

5. The laser system according to claim 1, further comprising:
an angle adjusting member furnished on the second path between the splitter element and the scanning lens assembly and configured to adjust a traveling direction of the second light beam.

6. The laser system according to claim 1, further comprising:
a detecting light source for projecting at least one detecting light beam along at least one emitting direction onto the work piece along; and
a sensor for receiving light traveling along at least one detecting direction from the work piece, to obtain at least one piece of light data corresponding to the work piece.

7. The laser system according to claim 6, wherein a wavelength range of the at least one detecting light beam is 400 nm˜750 nm.

8. The laser system according to claim 6, wherein an angle between the at least one emitting direction and the at least one detecting direction ranges 30˜100 degrees.

9. The laser system according to claim 6, further comprising:
a storage unit connected to the sensor and configured to store at least one reference corresponding to the work piece.

10. The laser system according to claim 9, further comprising:
a processing unit connected to the storage unit and the sensor and configured to compare the at least one piece of light data obtained by the sensor with the at least one reference stored in the storage unit, to determine a material of the work piece.

11. A laser flare machining method, comprising:
having a laser light source project a first light beam along a first path ;
having a splitter element split the first light beam into a second light beam traveling along a second path and a third light beam traveling along a third path; and
having a scanning lens assembly focus the second light beam and the third light beam at a machining position to process a work piece.

12. The laser flare machining method according to claim 11, wherein a peak wavelength of the first light beam ranges 1059 nm˜1075 nm, a FWHM value of the first light beam ranges 2 nm˜nm, a power value of the laser light source ranges 25 W˜50 W, and a pulse repetition rate of the laser light source ranges 10 KHz˜500 KHz.

13. The laser flare machining method according to claim 11, wherein a distance between the second path and the third path ranges 0.5 mm˜3 mm.

14. The laser flare machining method according to claim 11, wherein a focal length of the scanning lens assembly ranges 250 mm˜300 mm.

15. The laser flare machining method according to claim 11, further comprising:
adjusting a traveling direction of the second light beam by an angle adjusting member before the second light beam and the third light beam are focused by the scanning lens assembly to process the work piece.

16. The laser flare machining method according to claim 11, further comprising:
projecting at least one detecting light beam along at least one emitting direction onto the work piece by a detecting light source; and
receiving light traveling along at least one detecting direction from the work piece to obtain at least one piece of light data corresponding to the work piece by a sensor.

17. The laser flare machining method according to claim 16, wherein a wavelength range of the at least one detecting light beam is 400 nm˜750 nm.

18. The laser flare machining method according to claim 16, wherein an angle between the at least one emitting direction and the at least one detecting direction ranges 30˜100 degrees.

19. The laser flare machining method according to claim 16, further comprising:
storing the at least one piece of light data, which is obtained by the sensor, as at least one reference into a storage unit when a material of the work piece is known.

20. The laser flare machining method according to claim 16, further comprising:
comparing the at least one piece of light data obtained by the sensor with at least one reference corresponding to the work piece in a storage unit, to determine a material of the work piece.
